(19) United States
(12) Patent Application Publication
(10) Pub. No.: US 2016/0265196 A1
(43) Pub. Date: Sep. 15, 2016

(54) DISPLAY DEVICE OF WORKING VEHICLE, DISPLAY METHOD OF THE SAME, AND WORKING VEHICLE

(71) Applicant: KOMATSU LTD., Tokyo (JP)

(72) Inventor: Kouji Shimizu, Hiratsuka-shi (JP)

(21) Appl. No.: 14/394,518

(22) PCT Filed: Jul. 30, 2014
(86) PCT No.: PCT/JP2014/070130

§ 371 Date: Oct. 15, 2014

(51) Int. Cl. E02F 9/26; G08B 5/36; G08B 29/18; B60K 35/00; E02F 9/24

(52) U.S. Cl. CPC E02F 9/26; B60K 35/00; E02F 9/24; G08B 29/185; G08B 5/36; B60K 2350/352; E02F 3/325

(57) ABSTRACT

A display device of a working vehicle includes: a display screen configured to display an operation state of the working vehicle; an operation unit configured to switch display of the display screen; an abnormality detection unit configured to detect an abnormality of the working vehicle; an alarm output processing unit configured to perform an alarm output according to an abnormality detection state detected by the abnormality detection unit; and a cancellation function allocation unit configured to allocate a function to cancel the alarm output to the operation unit, wherein the alarm output processing unit performs processing of canceling the alarm output when an operation of the operation unit is performed in a state where the function to cancel the alarm output has been allocated.

### FIELD

The present invention relates to a display device of a working vehicle and a display method thereof capable of allocating a cancellation function of an alarm output to an operation switch even in a display device having a small number of operation switches.

### BACKGROUND

Conventionally, a display device is mounted on a working vehicle such as an excavator. The display device can display an operation state of the working vehicle on a display screen and can switch display of the display screen using a predetermined operation unit. Further, the display device can set or cancel various functions by an operation of an operation unit, referring to display content on the display screen.

Further, when an abnormality has occurred in the working vehicle, the display device sounds an alarm buzzer, and displays the occurrence of the abnormality and a type of the abnormality on the display screen to allow an operator to recognize that the working vehicle is in an abnormality state. However, after recognizing the abnormality state, the operator sometimes wishes to stop the sound output. Therefore, in Patent Literature 1, a buzzer cancellation function to stop the sound output of the alarm buzzer is allocated to a dedicated operation switch specified in advance.

### CITATION LIST

### Patent Literature

Patent Literature 1: Japanese Laid-open Patent Publication No. 9-316936

### SUMMARY

### Technical Problem

However, a small working vehicle such as a small excavator mounts a display device including a display screen having a minimum necessary size, and makes a space occupied by the display device small. Therefore, in the display device of the small working vehicle, the number of operation switches for operating the display device is limited, and if an important function or a function having high use frequency is allocated to operation switches, the above-described buzzer cancellation function, which is a special function, cannot be allocated to an operation switch.

The present invention has been made in view of the foregoing, and an objective is to provide a display device of a working vehicle, a display method of the same, and a working vehicle capable of allocating a cancellation function of an alarm output to an operation switch even in a display device having a small number of operation switches.

### Solution to Problem

To solve the above-described problem and achieve the object, a display device of a working vehicle according to the present invention includes: a display screen configured to display an operation state of the working vehicle; an operation unit configured to switch display of the display screen; an abnormality detection unit configured to detect an abnormality of the working vehicle; an alarm output processing unit configured to perform an alarm output according to an abnormality detection state detected by the abnormality detection unit; and a cancellation function allocation unit configured to allocate a function to cancel the alarm output to the operation unit, wherein the alarm output processing unit performs processing of canceling the alarm output when an operation of the operation unit is performed in a state where the function to cancel the alarm output has been allocated.

Moreover, in the above-described display device of a working vehicle according to the present invention, the cancellation function allocation unit allocates effectiveness/ineffectiveness of the function to cancel the alarm output to the operation unit according to the abnormality detection state detected by the abnormality detection unit.

Moreover, the above-described display device of a working vehicle according to the present invention further includes a screen display control unit configured to perform guide display that guides cancellation of the alarm output by the operation unit is possible on the display screen when the cancellation function allocation unit allocates the function to cancel the alarm output to the operation unit.

Moreover, in the above-described display device of a working vehicle according to the present invention, the screen display control unit performs guide display as a guide icon in a position on the display screen corresponding to a position of the operation unit.

Moreover, in the above-described display device of a working vehicle according to the present invention, the operation unit is arranged at an end portion of the display device, and the guide icon is arranged in an adjacent position corresponding to the operation unit and an end portion of the display screen.

Moreover, a display device of a working vehicle according to the present invention includes: a display screen configured to display an operation state of the working vehicle; an operation unit configured to switch display of the display screen; an abnormality detection unit configured to detect an abnormality of the working vehicle; an alarm output processing unit configured to perform an alarm output according to an abnormality detection state detected by the abnormality detection unit; a cancellation function allocation unit configured to allocate effectiveness/ineffectiveness of a cancellation function of the alarm output to a specific operation switch arranged at an upper right end of the operation unit according to the abnormality detection state detected by the abnormality detection unit; and a screen display control unit configured to perform, when the cancellation function allocation unit allocates the cancellation function of the alarm output to a specific operation switch of the operation unit, guide display that guides cancellation of the alarm output by the specific operation switch is possible at an upper right end on the display screen and in a position corresponding to a position of the specific operation switch, wherein the alarm output processing unit performs processing of canceling the alarm output when an operation of the specific operation switch is performed in a state where the cancellation function has been allocated to the alarm output.

Moreover, according to the present invention, a display method of a display device of a working vehicle including a display screen that displays an operation state of the working vehicle, and an operation unit that switches display of the display screen includes: an abnormality detection step of detecting an abnormality of the working vehicle; an alarm output processing step of performing an alarm output according to an abnormality detection state detected by the abnormality detection step; a cancellation function allocation step of allocating a function to cancel the alarm output to the operation unit; and an alarm output cancellation step of canceling the alarm output when an operation of the operation unit is performed in a state where the function to cancel the alarm output has been allocated.

Moreover, in the above-described display method of a display device of a working vehicle according to the present invention, the cancellation function allocation step allocates effectiveness/ineffectiveness of the function to cancel the alarm output to the operation unit according to the abnormality detection state detected by the abnormality detection step.

Moreover, the above-described display method of a display device of a working vehicle according to the present invention further includes a screen display control step of performing guide display that guides cancellation of the alarm output by the operation unit is possible on the display screen when the cancellation function allocation step allocates the function to cancel the alarm output to the operation unit.

Moreover, in the above-described display method of a display device of a working vehicle according to the present invention, the screen display control step performs guide display as a guide icon in a position on the display screen corresponding to a position of the operation unit.

Moreover, in the above-described display method of a display device of a working vehicle according to the present invention, the operation unit is arranged at an end portion of the display device, and the guide icon is arranged in an adjacent position corresponding to the operation unit and an end portion of the display screen.

Moreover, a working vehicle according to the present invention includes the above-described display device.

According to the present invention, a function to cancel an alarm output is allocated to an operation unit, and when an operation of the operation unit is performed in a state where the function to cancel an alarm output has been allocated, the alarm output is cancelled. Therefore, even a display device having a small number of operation switches of the operation unit can allocate the cancellation function of an alarm output to an operation switch.

### BRIEF DESCRIPTION OF DRAWINGS

FIG. 1 is a perspective view illustrating an overall configuration of a small excavator as a working vehicle that mounts a display device of a working vehicle that is an embodiment of the present invention.

FIG. 2 is a perspective view when a front side is viewed from an operation seat side of the small excavator.

FIG. 3 is a block diagram illustrating a functional configuration of the display device and configurations of principal parts of a control system around the display device.

FIG. 4 is a diagram illustrating an appearance configuration of the display device.

FIG. 5 is a diagram illustrating a transition to a user menu screen.

FIG. 6 is a diagram illustrating a transition to a working mode setting screen.

FIG. 7 is a diagram illustrating a transition in which guide display of a busser cancellation function is performed at the time of occurrence of an abnormality.

FIG. 8 is a flowchart illustrating an alarm processing procedure by a display device controller at the time of occurrence of an abnormality.

FIG. 9 is a diagram illustrating an example of abnormality detection state information.

FIG. 10 is a diagram illustrating a transition example of a display screen of when an abnormality in which an action code is “L01” and an alarm buzzer does not sound has been detected.

FIG. 11 is a diagram illustrating a transition example of a display screen of when an abnormality in which an action code is “L01”, an alarm buzzer does not sound, and a buzzer cancellation function is effective has been detected.

FIG. 12 is a diagram illustrating a transition example of a display screen of when an abnormality in which an action code is “L04”, an alarm buzzer sounds, and the buzzer cancellation function is ineffective has been detected.

FIG. 13 is a diagram illustrating a transition example of a display screen of when an abnormality in which an action code is “L04”, an alarm buzzer sounds, and the buzzer cancellation function is effective has been detected.

FIG. 14 is a diagram illustrating a screen display example of when four abnormalities with the action code of “L01” have been detected.

FIG. 15 is a diagram illustrating a screen display example of when four abnormalities with an action code of “L03” have been detected.

FIG. 16 is a diagram illustrating an example of a display screen illustrating an occurring failure list.

### DESCRIPTION OF EMBODIMENTS

Hereinafter, embodiments of the invention will be described with reference to the appended drawings.

[An Overall Configuration of a Small Excavator]

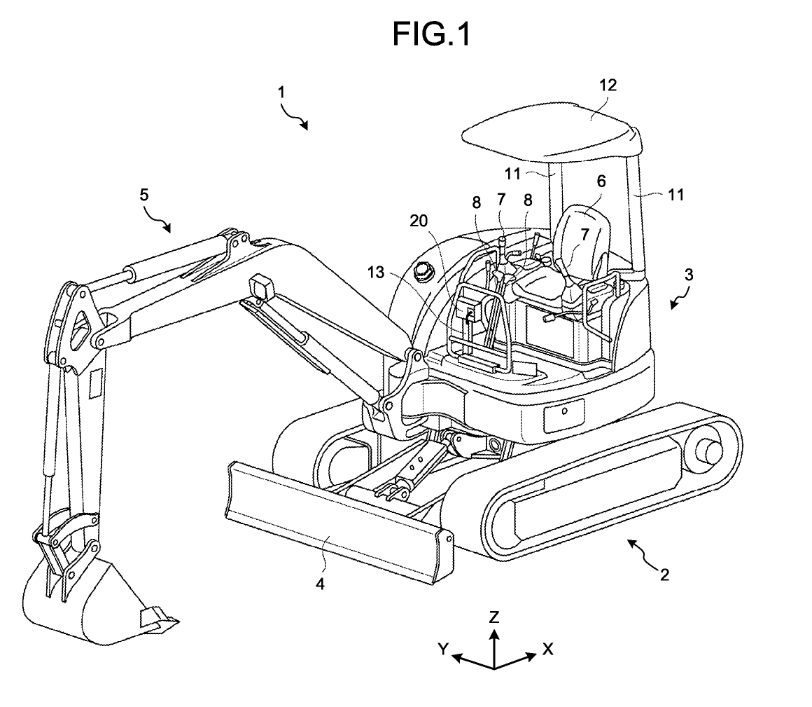

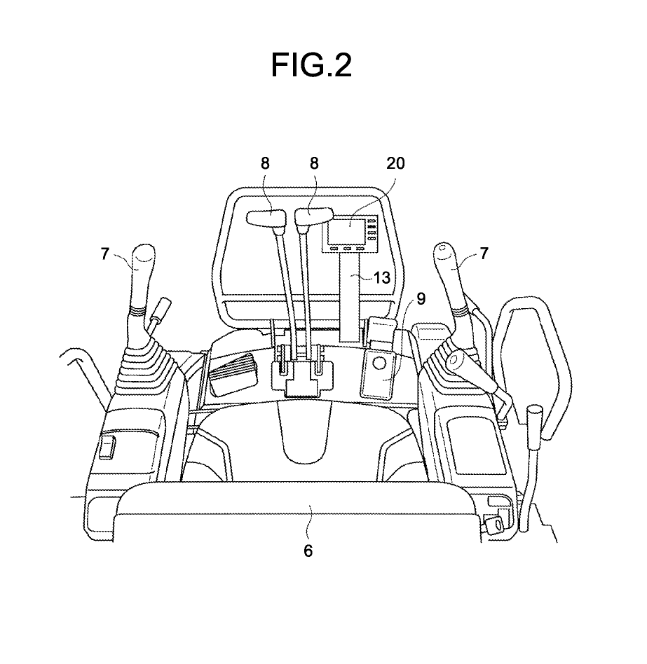

FIG. 1 is a perspective view illustrating an overall configuration of a small excavator 1 as a working vehicle that mounts a display device of a working vehicle that is an embodiment of the present invention. Further, FIG. 2 is a perspective view when a front side is viewed from an operator seat 6 side of the small excavator 1. In FIGS. 1 and 2, the small excavator 1 mounts an upper swing body 3 on an upper portion of a crawler type lower traveling body 2 in a freely swingable manner. A blade 4 that can be lifted by a hydraulic actuator is provided at a front side of the lower traveling body 2. Further, a working machine 5 is provided at a front side of the upper swing body 3. The working machine 5 is configured from a boom, an arm, and a bucket, and drives the boom, the arm, and the bucket with separate hydraulic actuators, respectively, thereby to perform excavation work, and the like.

Working machine levers 7 are respectively provided at right and left positions of the operator seat 6 in the upper swing body 3. Further, a pair of travel levers 8 and an operation pedal 9 for swinging the boom are provided on a front side of a floor. Further, the small excavator 1 has a canopy specification. A roof 12 supported by two supports 11 vertically arranged on the upper swing body 3 is provided at an upper side of the operator seat 6. Further, a display device 20 supported by a support arm 13 vertically arranged on the floor is provided at a side portion of the travel levers 8. Note that the position of the display device 20 is an example, and may be arranged in a console provided at a right side of the operator seat 6.

Although details of the display device 20 will be described below, the display device 20 includes a liquid crystal display of about 3.5 inches, for example, and display content can be switched by an operation of an operation unit made of a plurality of operation keys. Note that, in the description below, switching of a display screen of a display unit 31 will be appropriately referred to as a transition of a display screen. That is, the display device 20 can display an operation state of the small excavator 1 on the display screen, and can switch the display of the display screen using the operation unit. Further, the display device 20 can set or cancel various functions by an operation of the operation unit, referring to the display content on the display screen. Examples of the display content on the display screen include, for example, a service meter (an accumulated operation time), an engine water temperature meter, a fuel meter, a working oil temperature meter, a travel speed stage monitor, an electrical system alarm monitor, a fuel efficiency meter, and a current time. These pieces of content are displayed at the same time or by switching of the display screen. Note that the display device 20 may be a touch panel that incorporates a plurality of operation switches on the liquid crystal display, and integrates a display function and an operation function.

[A Functional Configuration of a Control System Including a Display Device]

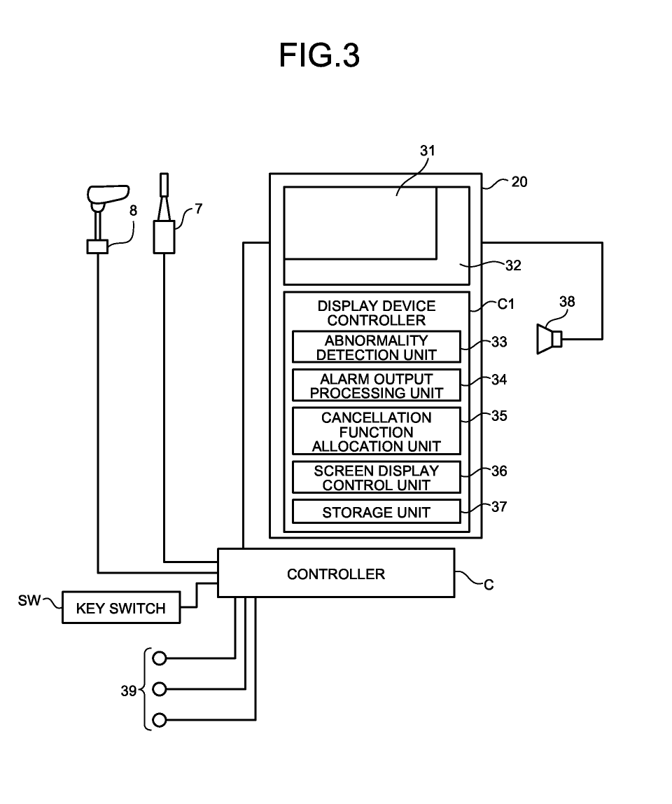

FIG. 3 is a block diagram illustrating a functional configuration of the display device 20 and configurations of principal parts of a control system around the display device 20. The display device 20 is realized by an operation unit 32 to which various instructions and information are input by an operator or a service man, a display unit 31 realized by a liquid crystal display screen, and the like, as a display screen that displays various types of information including operation information of the small excavator 1, a CPU, and the like. The display device 20 includes a display device controller C1 that controls an overall operation of the display device 20. Note that a controller C and an alarm buzzer 38 are connected to the display device 20.

Further, the display device controller C1 includes an abnormality detection unit 33, an alarm output processing unit 34, a cancellation function allocation unit 35, a screen display control unit 36, and a storage unit 37. The abnormality detection unit 33 detects an abnormality of the small excavator 1. The alarm output processing unit 34 performs an alarm output to the alarm buzzer 38 according to an abnormality detection state detected by the abnormality detection unit 33. The cancellation function allocation unit 35 temporarily allocates a cancellation function (buzzer cancellation function) of an alarm output to a specific operation switch (hereinafter, appropriately referred to as function switch) of the operation unit 32. That is, the cancellation function allocation unit 35 allocates effectiveness/ineffectiveness of the buzzer cancellation function to a specific operation switch of the operation unit 32 according to the abnormality detection state detected by the abnormality detection unit 33. Note that, when an operation of the specific operation switch is performed in a state where the buzzer cancellation function is temporarily allocated, the alarm output processing unit 34 performs processing of canceling an alarm output of the alarm buzzer 38 as well.

The screen display control unit 36 performs guide display that guides cancellation of an alarm output by the specific operation switch, on the display unit 31 when the cancellation function allocation unit 35 allocates the buzzer cancellation function to the specific operation switch of the operation unit 32. This guide display is displayed at a specific position on the display unit 31 corresponding to a position of the allocated specific operation switch, as a guide icon.

The storage unit 37 holds information necessary for control of the display device controller C1, setting information indicating content set to the various functions, and the like. Especially, abnormality detection state information is stored in the storage unit 37. The abnormality detection state information includes items, such as content of the abnormality detection state, an action code that indicates the degree of priority (abnormality level) of the abnormality detection state, an abnormality detection icon, whether the alarm buzzer 38 performs an alarm output and content of the alarm output, for example, a sound pattern (three consecutive sounds, a continuous sound, or the like) of the alarm buzzer as described below, the effectiveness/ineffectiveness of the buzzer cancellation function, an error code, an abnormality detection corresponding message, and correspondence among these items is stored in advance. Further, the degree of priority of the alarm buzzer of when the alarm buzzer 38 outputs a sound is determined with respect to the content of each abnormality detection state, as one of the abnormality detection state information, and is stored in the storage unit 37. Details of the abnormality detection state information will be described below.

A plurality of sensors 39 that detects the temperature of engine cooling water, a working oil temperature, a fuel remaining amount, and the like is connected to the controller C. Further, operation amounts of the travel levers 8 and the working machine levers 7 are input to the controller C. The controller C drives various actuators to be controlled (not illustrated) based on the operation amounts of the travel levers 8, the working machine levers 7, and the like, to operate the working machine 5, to cause the upper swing body 3 to swing, or to cause the lower traveling body 2 to travel, while referring to detection values detected by the sensors 39.

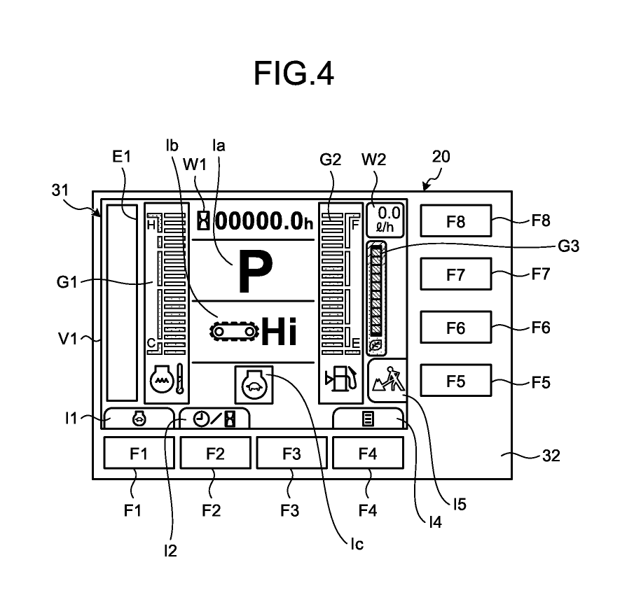

Further, a key switch SW is connected to the controller C. When the key switch SW is turned ON, and electricity is supplied from a battery (not illustrated) to the controller C and the display device 20, power is applied. When the power is applied, the display device 20 displays a standard screen illustrated in FIG. 4, for example. Note that the detection values of the sensors 39 and the like input to the controller C can be displayed on the display screen of the display unit 31 as monitoring information.

[An Appearance Configuration of a Display Device]

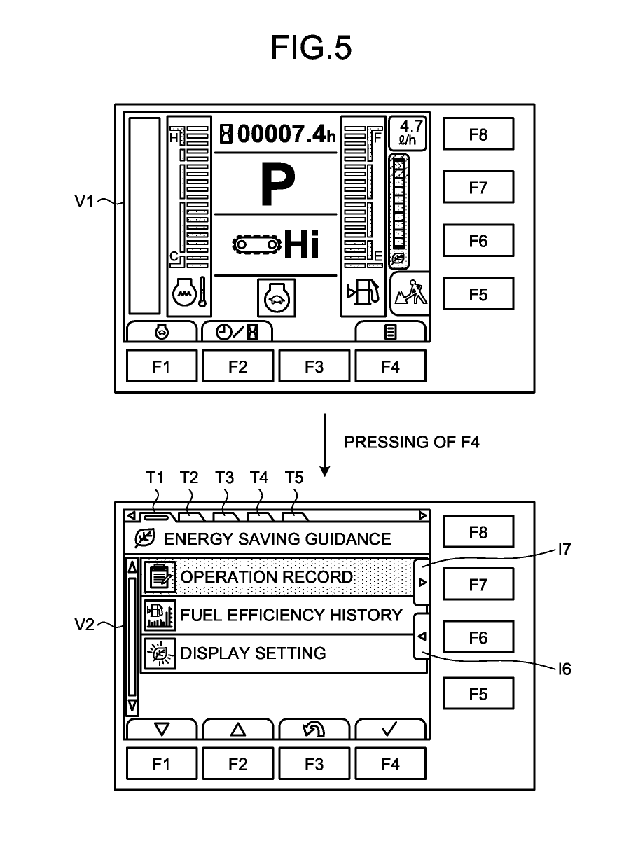

FIG. 4 is a diagram illustrating an appearance configuration of the display device 20. As illustrated in FIG. 4, the operation unit 32 is arranged below and at a right side of the display unit 31, and is configured from operation switches F1 to F8 that are a plurality of function switches. The operation switches F1 to F4 positioned below and respectively displayed as “F1” to F4″ from the left side are switches for inputting signals corresponding to guide icons I1 to I4 displayed above the respective operation switches F1 to F4 and at a lower portion of the display unit 31. The operation switches F5 to F8 positioned at a right side of the display unit 31, and respectively displayed as “F5” to “F8” from the lower side are switches for inputting signals corresponding to guide icons I5 to I8 displayed at the left side of the respective operation switches F5 to F8, and at the right side of the display unit 31. Note that a display screen V1 of the display unit 31 illustrated in FIG. 4 is a standard screen initially displayed when the key switch SW is turned ON, and in which the guide icons I3, and I6 to I8 are not displayed. The guide icons I1 to I8 are set for each display screen to be switched in advance. For example, as illustrated in FIG. 5, on a switched display screen, the guide icons I6 and I7 may be displayed. Therefore, the guide icons I3, and I6 to I8 may be displayed on the standard screen according to a type or a function of the working vehicle. Then, when the guide icons I1 to I8 are displayed, the operation switches F1 to F8 corresponding to the displayed guide icons I1 to I8 are allocated and operated as function switches corresponding to display content. When the operation switches F1 to F8 at positioned corresponding to the positions where the guide icons I1 to I8 are displayed are pressed, functions of respective guide icons function. Note that the operation switches F1 to F8 of the operation unit 32 may be arranged at upper/lower/right/left end portions of the display device 1, and the above-described guide icons I1 to I8 may just be arranged at positions adjacent to and corresponding to the operation switches F1 to F8 of the operation unit 32, and end portions on the display screen of the display unit 31.

Here, the right hand side is defined to be right, and the left hand side is defined to be left when the operator sits on the operator seat 6. An engine water temperature G1 that indicates a water temperature of cooling water of an engine is arranged in a left side area on a display screen V1 illustrated in FIG. 4 and at a right side of an area E1. Further, a fuel efficiency meter window W2 is displayed in an upper portion of a right side area on the display screen V1, and in an area where the guide icon I8 is displayed. The fuel efficiency meter window W2 displays a fuel consumption amount (average fuel efficiency) per unit time. Further, a fuel consumption gauge G3 that indicates an instantaneous fuel consumption amount in a bar manner is displayed in an area between the fuel efficiency meter window W2 and the guide icon I5, and an area including an area where the guide icons I6 and I7 are displayed on the monitor. Further, a fuel level gauge G2 that indicates a level of a remaining amount of the fuel is displayed at a left side of the fuel efficiency consumption gauge G3.

Further, a service meter/clock display window W1, a working mode icon Ia, a travel mode icon Ib, and an auto deceleration icon Ic are displayed in order from the upper side in a central area on the display screen V1, and between the engine water temperature G1 and the fuel efficiency consumption gauge G2. The service meter/clock display window W1 switches and displays a service meter that indicates an accumulated operation time and a clock, and FIG. 4 displays the service meter. The working mode icon Ia is an icon that displays a set working mode from among a plurality of working modes. The working mode icon Ia is displayed including a character of “P” when the set working mode is a P mode (power mode), “E” when the set working mode is an E mode (economy mode), “L” when the set working mode is an L mode (arm crane mode=lifted cargo mode), “B” when the set working mode is a B mode (breaker mode), or “ATT” when the set working mode is an ATT mode (attachment mode). The working mode icon Ia illustrated in FIG. 4 indicates that the P mode is set. The travel mode icon Ib displays “Lo” when the travel mode is set to a low speed, and “Hi” when the travel mode is set to a high speed. FIG. 4 displays an icon including the characters of “Hi” where the travel mode is set to a high speed. The auto deceleration icon Ic is an icon displayed when auto deceleration control is set, in which an engine speed is decreased to a predetermined engine speed when the working machine levers 7 are returned to neutral positions.

Note that icons that function as various indicators are displayed in the area E1 at the left side on the display screen V1. For example, an icon displayed when a seat belt is not worn, an icon that indicates an incoming mail received through wireless communication means, an icon displayed at the time of key ON of the key switch SW, and displaying that the engine is being driven, an icon displayed when the lock lever is in a locked state, an icon that displays a PM accumulation state of a particulate removing filter (called diesel particulate filter (DPF)) that removes a particulate matter (PM) contained in an exhaust gas of the engine, and the like are displayed.

An icon that guides display/non-display of the auto deceleration icon Ic is displayed in the guide icon I1 on the display screen V1. Here, when the operation switch F1 is pressed, the auto deceleration icon Ic becomes non-displayed. When the operation switch F1 is further pressed, the auto deceleration icon Ic is displayed, and setting of the auto deceleration control can be switched. In the guide icon I2, an icon that guides display switching of the service meter/clock is displayed. Here, every time the operation switch F2 is pressed, the content displayed in the service meter/clock display window W1 is switched between the service meter and the clock.

Further, an icon that guides user menu setting is displayed in the guide icon I4 on the display screen V1. Here, as illustrated in FIG. 5, when the operation switch F4 is pressed, the display screen V2 is displayed. On the display screen V2, for example, various types of user setting, confirmation of an operation history, and the like can be performed, and with an operation of the guide icons I1 to I8, the display screen can be switched to a display screen that displays various types of information. The display screen V2 of FIG. 5 illustrates a state in which a tab menu selection screen of energy saving guidance is displayed. Here, by selection of the tabs T1 to T5 using the operation switches F6 and F7, tab menu selection screens corresponding to the selected tabs T1 to T5 are displayed. That is, when the operation switch F7 is pressed, for example, the tab menu selection screens are switched from the left to right, from the tab T1 to T2, then to T3. When the operation switch F6 is pressed, the tab menu selection screens are switched from the right to left, from the tab T5 to T4, then to T3. Examples of the tab menu selection screen include vehicle body setting information, DPF regeneration, maintenance, monitor setting, and the like, in addition to the energy saving guidance. Note that the guide icons I1 and I2 on the display screen V2 guide item selection on the current tab menu selection screen, and when the operation switch F1 is pressed, the selection items are moved to a lower part, and when the operation switch F2 is pressed, the selection items are moved to an upper part.

FIG. 5 illustrates that, as the selection item, any of an operation record, a fuel efficiency history, and display setting can be selected. Further, the guide icon I3 guides return to the previous display screen before switching to the displayed display screen, and when the operation switch F3 is pressed, the display screen of the display unit 31 is returned from the display screen V2 to the display screen V1. Further, the guide icon I4 guides selection determination, and when the operation switch F4 is pressed, selection of the currently set item is determined. FIG. 5 illustrates a state in which the selection item of the operation record is being selected, a display form of an item section that indicates the operation record is different from other selection items so that the selected selection item can be distinguished from other selection items, and in this state, when the operation switch F4 is pressed, information related to the operation record is displayed on the display screen, that is, in the display unit 31, as described above. An example of the information related to the operation record includes an idling time in which the engine is in an idling operation in the past operation. Further, when the fuel efficiency history is selected as the selection item, as information related to the fuel efficiency history, for example, there are a graph that expresses a transition of an average fuel efficiency of each day of most recent one week, and the like, and the graph, and the like are displayed in the display unit 31. When the display setting is selected as the selection item, for example, a display screen for setting display/non-display of the fuel consumption gauge G3, and the like are displayed in the display unit 31.

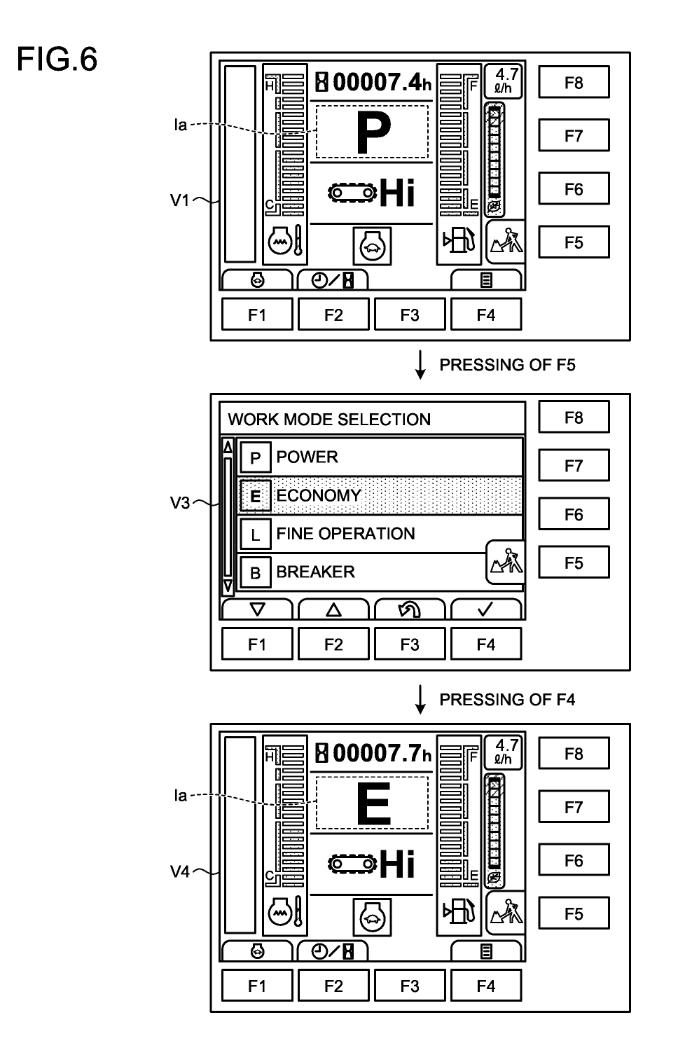

Further, in the guide icon I5 on the display screen V1, an icon that guides setting of a working mode is displayed. Here, as illustrated in FIG. 6, when the operation switch F5 is pressed, the display screen V3 is displayed. When the operation switches F1 and F2 are operated in a state where the display screen V3 is being displayed, a selection state of the working mode can be changed. The display screen V3 is a state where the E mode is selected. A display form of the item section that indicates the E economy is different from display forms of the item sections of other working modes so that the state where the E mode is selected can be distinguished. Note that the E mode (economy mode) is a mode that controls an engine output to suppresses the fuel consumption, and to secure a working speed of the P mode (power mode) level in light load word. Further, the P mode (power mode) controls the engine output to secure a large work amount at the time of heavy excavation work. When the operation switch F4 is pressed in a state where the display screen V3 illustrated in FIG. 6 is being displayed, selection of the E mode is selected, and the display screen is switched and a display screen V4 is displayed, as illustrated in FIG. 6. The display screen V4 is a standard screen on which the working mode icon Ia is displayed as “E”, and displays that the working mode is changed and set to the E mode.

Note that the above-described display screen V2 is a user menu display screen on which a general user (an operator who operates the vehicle) performs setting and the like. However, the display screen V2 can be made transition to a service menu display screen on which an administrator performs setting. The “administrator” here is, for example, an administrator of a rental company of construction machines, a service man of a dealer of construction machines, or the like. The transition to the service menu display screen is executed by an operation that the general user does not know, for example, by using an operation switch and operating of the operation switch with a special operation. As described above, it is desirable to set the operation such that the general user cannot make a transition to the service menu display screen.

The service menu display screen can display menus necessary for the administrator to perform failure diagnosis or defect analysis during maintenance To be specific, the service menu display screen displays menus such as “monitoring” that displays a detection result of the item selected from the items detected by the sensors 39, “failure history” that displays a history of failure, “maintenance history” that displays a history of maintenance, “maintenance mode setting” in which mode setting is performed of during maintenance, “initial value setting” in which setting of the presence or absence of an optional function and an initial value of monitoring, and the like.

[An Outline of Guide Display of a Buzzer Cancellation Function]

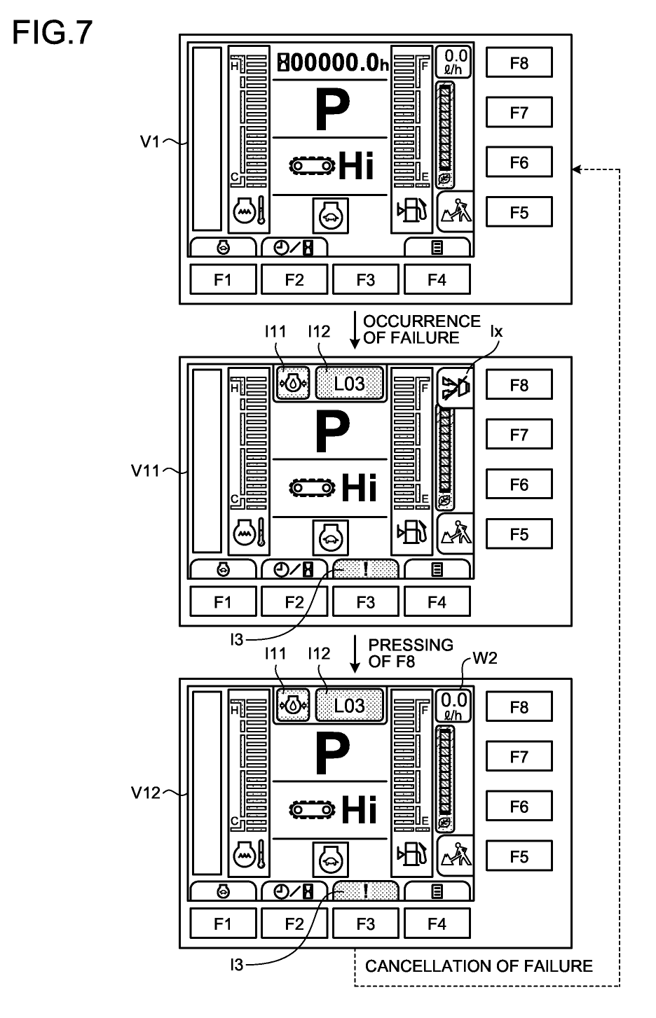

FIG. 7 is a diagram illustrating a transition of a display screen on which guide display of the buzzer cancellation function is performed at the time of occurrence of an abnormality (failure). When an abnormality in which a sound output of the alarm buzzer 38 is performed, and the buzzer cancellation function is set to be effective has occurred in the small excavator 1, the display screen V1 illustrated in FIG. 7 makes a transition to the display screen V11. The display screen V11 displays a buzzer cancellation icon Ix that is the guide icon I8 in a display position of the fuel efficiency meter window W2. The buzzer cancellation icon Ix is different from the guide icon allocated to each display screen, and is a temporary guide icon common to the display screens. In this case, a fuel consumption amount (average fuel efficiency) per unit time that has been displayed in the fuel efficiency meter window W2 is not displayed. However, necessity or urgency to continuously inform the operator of the average fuel efficiency when an abnormality (failure) is occurring, and thus the buzzer cancellation icon Ix is displayed in the location where the fuel efficiency meter window W2 is displayed.

Note that, on the display screen V11 displays an icon I11 that is a symbol indicating the type of the abnormality and an icon I12 indicating an action code (L03 in the case of FIG. 7) corresponding to the type of the abnormality, in a display position of the service meter/clock display window W1 side by side. Further, the display screen V11 displays an icon that guides detailed display of content of the abnormality detection state as the guide icon I3. When the operation switch F8 is pressed in a state where the display screen V11 is being displayed, the buzzer cancellation function is selected. Following that, the sound of the alarm buzzer 38 is stopped, and the display screen of the display unit 31 is made transition to the display screen V12, as illustrated in FIG. 7. On the display screen V12, the buzzer cancellation icon Ix disappears, and the fuel efficiency meter window W2 is displayed again, and display of the icons I11, I12, and I3 is maintained similarly to the display screen V11. Following that, measures against a cause of the abnormality (failure) are taken. In a state where the abnormality (abnormality) has been cancelled (failure cancellation), that is, when the abnormality detection state has been cancelled, the display screen is made transition to the display screen V1.

[Alarm Processing at the Time of Occurrence of an Abnormality]

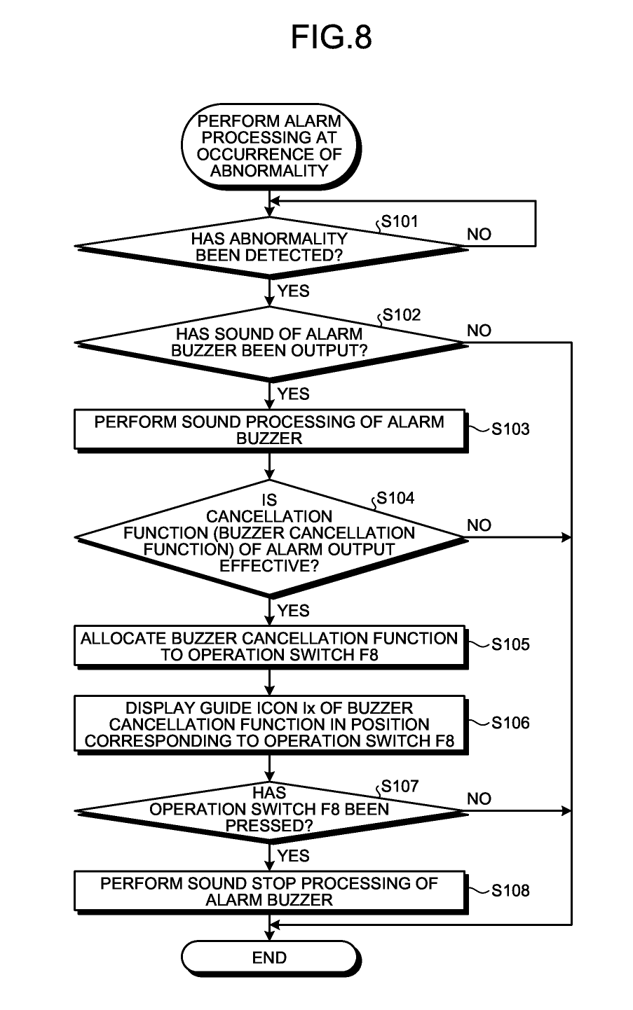

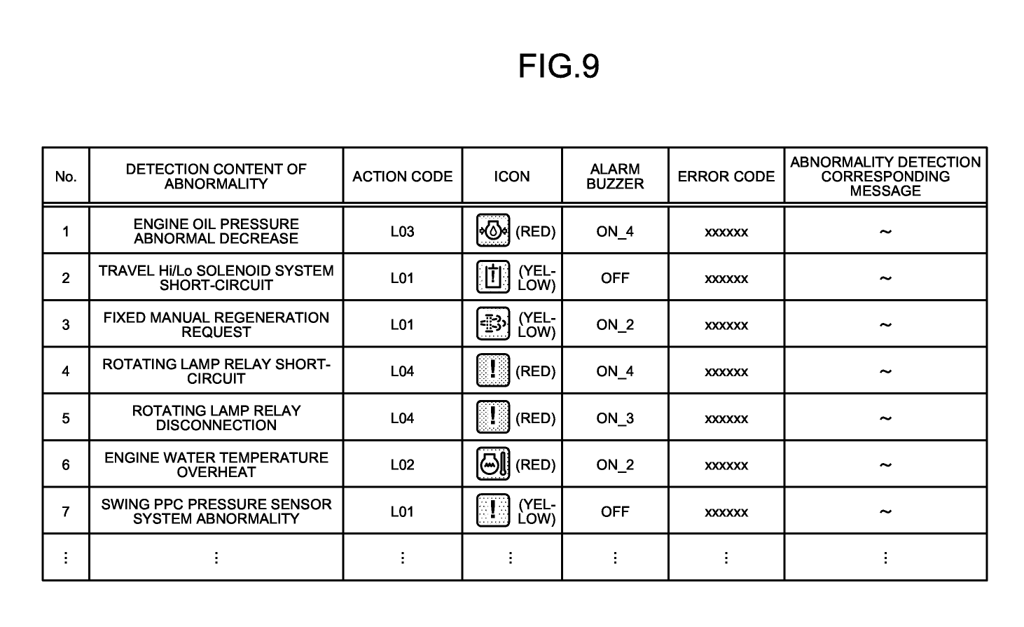

Here, alarm processing by the display device controller C1 at the time of occurrence of an abnormality will be described. FIG. 8 is a flowchart illustrating an alarm processing procedure by the display device controller C1 at the time of occurrence of an abnormality. As illustrated in FIG. 8, the display device controller C1 determines whether the abnormality detection unit 33 has detected an abnormality (step S101). When the abnormality detection unit 33 has not detected an abnormality (No in step S101), the display device controller C1 repeats the determination processing of step S101. When the abnormality detection unit 33 has detected an abnormality (Yes in step S101), the alarm output processing unit 34 refers to the abnormality detection state information (FIG. 9) held in the storage unit 37, and further determines whether the abnormality is an abnormality that a sound of the alarm buzzer 38 is output (step S102).

When the abnormality is an abnormality that a sound of the alarm buzzer 38 should be output (Yes in step S102), the alarm output processing unit 34 performs sound processing of the alarm buzzer 38 (step S103). Following that, the cancellation function allocation unit 35 determines whether the occurring abnormality is an abnormality in which the buzzer cancellation function is effective (step S104). When the occurring abnormality is an abnormality in which the buzzer cancellation function is effective (Yes in step S104), the cancellation function allocation unit 35 allocates the buzzer cancellation function to the operation switch F8 (step S105). Further, the screen display control unit 36 displays the buzzer cancellation icon Ix that is a guide icon of the buzzer cancellation function in a display position corresponding to the operation switch F8, that is, in a position at the left side of the operation switch F8 and where the fuel efficiency meter window W2 has been displayed (step S106).

Following that, whether the operation switch F8 has been pressed is determined (step S107). When the operation switch F8 has not been pressed (No in step S107), the present processing is terminated. When the operation switch F8 has been pressed (Yes in step S107), the alarm output processing unit 34 performs stop processing of the sound of the alarm buzzer 38 (step S108), and terminates the present processing. Meanwhile, when the occurring abnormality is not an abnormality that the sound of the alarm buzzer 38 should be output (No in step S102), the alarm output processing unit 34 also terminates the present processing. Further, when the abnormality is not an abnormality in which the buzzer cancellation function is effective (No in step S104), the alarm output processing unit 34 terminates the present processing while keeping the sound of the alarm buzzer 38 being output. Note that the above-descried processing is repeatedly processed.

[An Example of Abnormality Detection State Information]

FIG. 9 is a diagram illustrating an example of the abnormality detection state information stored in the storage unit 37. In “No. 1” of FIG. 9, an action code “L03”, corresponding icon content, an alarm buzzer “ON_4”, a corresponding error code, and a corresponding abnormality detection corresponding message are stored with respect to detection content of an abnormality of “engine oil pressure abnormal decrease”. In “No. 2”, an action code “L01”, corresponding icon content, an alarm buzzer “OFF”, a corresponding error code, and a corresponding abnormality detection corresponding message are stored with respect to detection content of an abnormality of “travel Hi/Lo solenoid system short-circuit”. In “No. 3”, the action code “L01”, the corresponding icon content, an alarm buzzer “ON_2”, a corresponding error code, and a corresponding abnormality detection corresponding message are stored with respect to detection content of an abnormality of “fixed manual regeneration request” related to DPF. In “No. 4”, an action code “L04”, corresponding icon content, an alarm buzzer “ON_4”, a corresponding error code, and a corresponding abnormality detection corresponding message are stored with respect to detection content of an abnormality of “rotating lamp relay short-circuit”. In “No. 5”, the action code “L04”, the corresponding icon content, an alarm buzzer “ON_3”, a corresponding error code, and a corresponding abnormality detection corresponding message are stored with respect to detection content of an abnormality of “rotating lamp relay disconnection”. In “No. 6”, an action code “L02”, corresponding icon content, the alarm buzzer “ON_2”, the corresponding error code, and the corresponding abnormality detection corresponding message are stored with respect to detection content of an abnormality of “engine water temperature overheat”. In “No. 7”, the action code “L01”, the corresponding icon content, the alarm buzzer “OFF”, the corresponding error code, and the corresponding abnormality detection corresponding message are stored with respect to detection content of an abnormality of “swing PPC pressure sensor system abnormality”.

The action code indicates the degree of priority level of an abnormality, as described above, and indicates that the abnormality level becomes higher from L01 to L02, and further from L03 to L04, in order. That is, the action code L04 indicates a severe abnormality. Further, the icon is a symbol icon indicating content of an abnormality, and indicates the height of the abnormality level by color display. For example, the detection content of the abnormalities of No. 1, and No. 4 to 6 are displayed in red, and the detection content of the abnormalities of No. 2, and No. 3, No. 7 are displayed in yellow. The fact that abnormality level of the abnormalities of No. 1, and No. 4 to 6 is higher than that of No. 2, and No. 3, No. 7 can be easily recognized. Note that the action code is also displayed in the same color as the icon when being displayed on the display screen of the display unit 31.

Note that, the presence or absence of the sound of the alarm buzzer 38 may be set for each action code. As described in the example of the abnormality detection state information illustrated in FIG. 9, the detection content of the abnormalities of “No. 2”, and “No. 3” are both the same action code “L01”. However, in “No. 2”, the alarm buzzer OFF″ is set and the absence of the sound of the alarm buzzer 38 is set, while in “No. 3”, the alarm buzzer “ON_2” is set and the presence of the sound of the alarm buzzer 38 is set. The setting of the presence or absence of the sound of the alarm buzzer 38 is different with respect to the same action code. However, even if the detection content of an abnormality is different, the presence of the sound of the alarm buzzer 38 may be set if the same action code is set. Alternatively, even if the detection content of an abnormality is different, the absence of the sound of the alarm buzzer 38 may be set if the same action code is set. That is, when a plurality of abnormalities has been detected, and if the plurality of abnormalities has the same action code, and for example, if the action codes of the plurality of abnormalities are the same “L01”, the absence of the sound of the alarm buzzer 38 may be set to all of the plurality of abnormalities. If the plurality of the action codes is the same “L04”, the presence of the sound of the alarm buzzer 38 may be set.

In the abnormality detection state information, when the alarm buzzer is “OFF”, the sound of the alarm buzzer 38 is not output. When the alarm buzzer is “ON_1” to “ON_6”, the alarm buzzer sounds according to the sound pattern. When the alarm buzzer is “ON_1” and “ON_4”, the alarm buzzer sounds with three consecutive sounds. When the alarm buzzer is “ON_2” and “ON_5”, the alarm buzzer sounds with a discontinuous sound. When the alarm buzzer is “ON_3” and “ON_6”, the alarm buzzer sounds with a continuous sound. That is, the sound state of the alarm buzzer 38 is set to be different according to the detection content of an abnormality.

Further, when the alarm buzzer is “ON_1” to “ON_3”, the buzzer cancellation function is effective, and when the alarm buzzer is “ON_4” to “ON_6”, the buzzer cancellation function is ineffective. That is, when the alarm buzzer is “ON_4” to “ON_6”, the operator cannot perform buzzer cancellation, and thus the alarm buzzer 38 continues to sound as long as the abnormality is continued.

[A Transition Example of a Display Screen with Respect to an Abnormality Detection State]

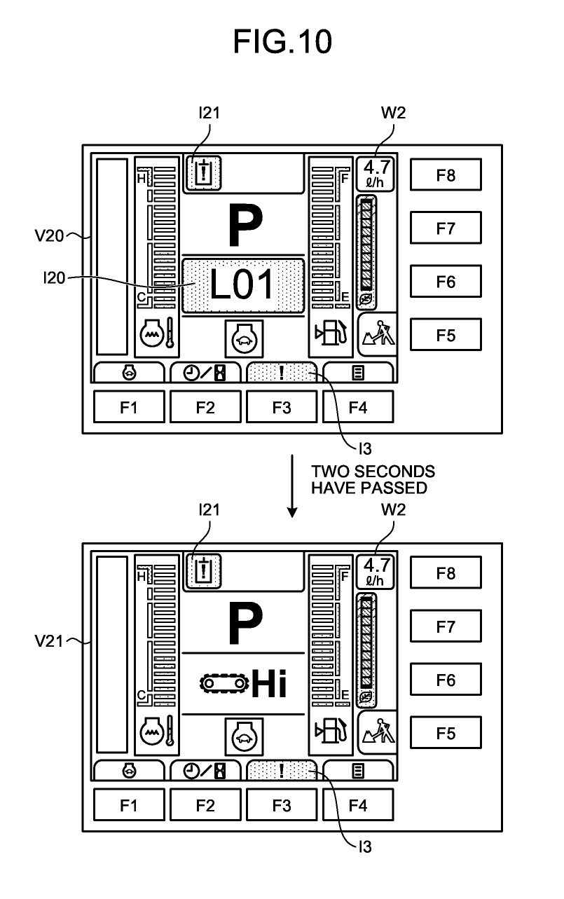

FIG. 10 is a diagram illustrating a transition example of a display screen of when the abnormality in which the action code is “L01” and the alarm buzzer 38 does not sound has been detected. To be specific, FIG. 10 illustrates a case in which the abnormality of “travel Hi/Lo solenoid system short-circuit” of “No. 2” illustrated in FIG. 9 has been detected. When the abnormality has been detected, the alarm buzzer 38 does not sound, and as illustrated in FIG. 10, first, a large yellow icon I20 that indicates the action code “L01” is pop-up displayed in the center of the display screen V20, and an icon I21 that indicates the abnormality of “travel Hi/Lo solenoid system short-circuit” is displayed in an upper portion of the display screen V20. Note that the abnormality of “travel Hi/Lo solenoid system short-circuit” means that electrical short circuit has occurred in a solenoid for moving a hydraulic valve for switching the travel mode for some reason. Further, the guide icon I3 that guides detailed display of the content of the abnormality detection state is displayed. Note that, in this abnormality, the alarm buzzer 38 does not sound, and thus the buzzer cancellation function is unnecessary. Therefore, the buzzer cancellation icon Ix is not displayed. Then, when a predetermined time, for example, two seconds have passed from a display state of the display screen V20 on which the icon I20 that indicates the occurrence of the abnormality is displayed, the icon I20 is deleted from the display screen V20, and the display screen is made transition to the display screen V21.

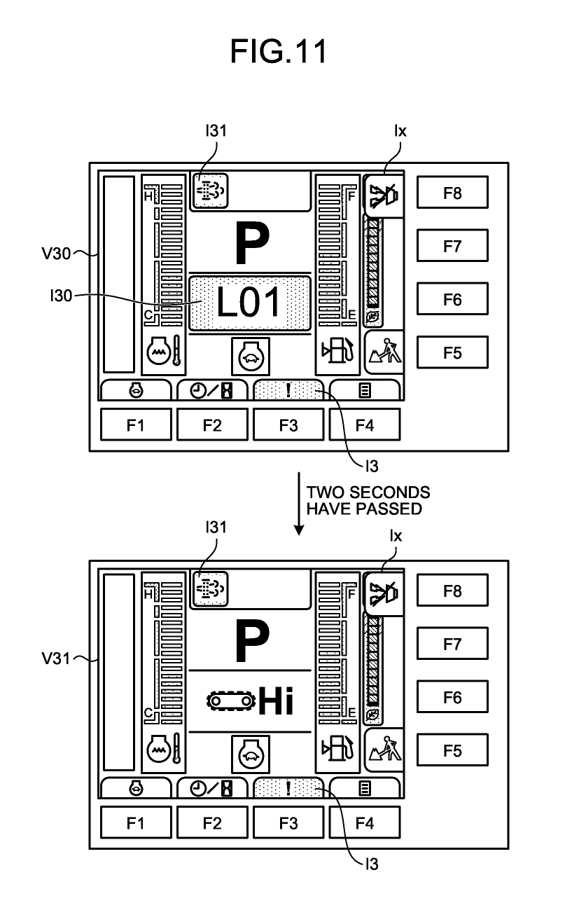

FIG. 11 is a diagram illustrating a transition example of a display screen of when an abnormality in which the action code is “L01”, the alarm buzzer 38 outputs a sound, and the buzzer cancellation function is effective has been detected. To be specific, FIG. 11 illustrates a case in which the abnormality of “fixed manual regeneration request” of “No. 3” illustrated in FIG. 9 has been detected. When the abnormality has been detected, the alarm buzzer 38 outputs a sound, and as illustrated in FIG. 11, first, a large yellow icon I30 that indicates the action code “L01” is pop-up displayed in the center of a display screen V30, and an icon I31 that indicates the abnormality of “fixed manual regeneration request” is displayed in an upper portion of the display screen V30. Note that the abnormality of “fixed manual regeneration request” indicates that a predetermined amount of the particulate matter is accumulated in the DPF. That is, this abnormality indicates that processing (regeneration processing) of injecting a fuel into an exhaust path existing between the DPF and the engine, increasing the temperature of the exhaust gas, and burning the particulate matter accumulated in the DPF, in order to re-burn and remove the particulate matter accumulated in the DPF should be executed. To execute the regeneration processing of the DPF with respect to the abnormality of “fixed manual regeneration request”, the operator performs a predetermined operation, thereby to execute fuel injection control to the engine and the engine output control, and to execute the regeneration processing. Further, the guide icon I3 that guides detailed display of the content of the abnormality detection state is displayed. Further, the buzzer cancellation icon Ix is displayed. Then, when a predetermined time, for example, two seconds have passed from the display state of the display screen V30, the icon I30 is deleted from the display screen V30, and the display screen is made transition to a display screen V31. Note that, in a state where the buzzer cancellation icon Ix is displayed, the buzzer cancellation function is allocated to the operation switch F8. Then, the sound of the alarm buzzer 38 is stopped by pressing of the operation switch F8, the buzzer cancellation icon Ix is deleted, and the fuel efficiency meter window W2 is displayed again. Note that the buzzer cancellation icon Ix may be displayed by either display method of being displayed in place of the fuel efficiency meter window W2, or being superimposed and displayed on the fuel efficiency meter window W2. Further, as illustrated in FIG. 11, the buzzer cancellation icon Ix may be displayed by either display method of being superimposed on a part of the fuel efficiency consumption gauge G3 (FIG. 11), or being not superimposed on the fuel efficiency consumption gauge G3. In any method, the buzzer cancellation icon Ix is displayed at the left side of the operation switch F8, corresponding to the position of the operation switch F8.

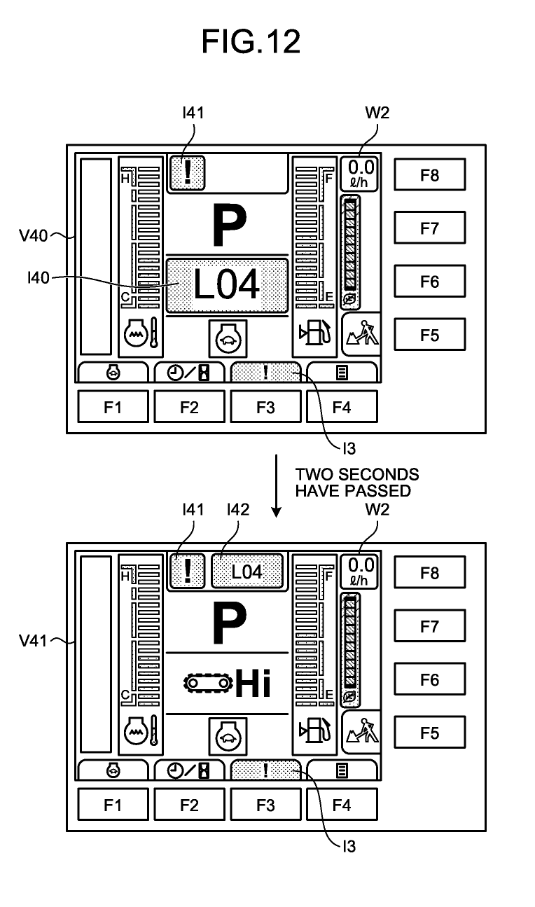

FIG. 12 is a diagram illustrating a transition example of a display screen of when an abnormality in which the action code is “L04”, the alarm buzzer 38 outputs a sound, and the buzzer cancellation function is ineffective has been detected. To be specific, FIG. 12 illustrates a case in which the abnormality of “rotating lamp relay short-circuit” of “No. 4” illustrated in FIG. 9 has been detected. When the abnormality has been detected, the alarm buzzer 38 outputs a sound, and as illustrated in FIG. 12, first, a large red icon I40 that indicates the action code “L04” is pop-up displayed in the center of the display screen V40, and an icon I41 that indicates the abnormality of “rotating lamp relay short-circuit” is displayed in an upper portion of the display screen V40. Note that, when the abnormality of “rotating lamp relay short-circuit” or “rotating lamp relay disconnection” has been detected, the reason why the action code is “L04”, and the abnormality is a severe abnormality in the highest level of the degree of priority is that it is necessary not to impair a correct operation of the rotating lamp for informing the surroundings that crane work will be performed by the small excavator 1. Further, the guide icon I3 that guides detailed display of the content of the abnormality detection state is displayed. Note that the buzzer cancellation function is ineffective, and thus the buzzer cancellation icon Ix is not displayed. Therefore, the operator cannot stop the sound of the alarm buzzer 38 as long as operating the key switch SW to turn OFF. Then, a predetermined time, for example, two seconds have passed from the display state of the display screen V40, the icon I40 is deleted from the display screen V40, and the display screen is made transition to a display screen V41 on which an icon I42 that is a small icon I40 is displayed adjacent to the icon I41, in place of the icon I40.

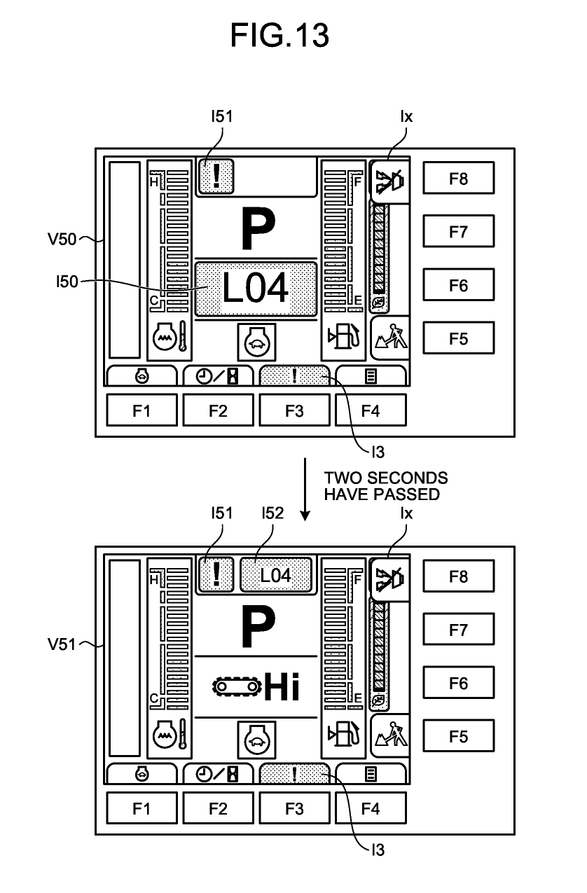

FIG. 13 is a diagram illustrating a transition example of a display screen of when an abnormality in which the action code is “L04”, the alarm buzzer 38 outputs a sound, and the buzzer cancellation function is effective has been detected. To be specific, FIG. 13 illustrates a case in which the abnormality of “rotating lamp relay disconnection” of “No. 5” illustrated in FIG. 9 has been detected. When the abnormality has been detected, the alarm buzzer 38 outputs a sound, and as illustrated in FIG. 12, first, a large red icon I50 that indicates the action code “L04” is pop-up displayed in the center of the display screen V50, and an icon I51 that indicates the abnormality of “rotating lamp relay disconnection” is displayed in an upper portion of the display screen V50. Note that the abnormality of “rotating lamp relay disconnection” is an abnormality as follows. The rotating lamp is installed on an upper surface of the roof 12, and when the small excavator 1 performs crane work, the rotating lamp lights up or flashes in conjunction with (relaying) a predetermined operation associated with the crane work to call for attention to the surroundings of the small excavator 1. Here, if disconnection is caused in a relay circuit for operating the rotating lamp for some reason, the rotating lamp does not light up or flash, and calling for attention may not be performed. Therefore, when the disconnection is caused in the relay of the rotating lamp, the abnormality of “rotating lamp relay disconnection” is displayed on the display screen, thereby to urge the operator to take appropriate measures and not to impair the correct operation of the rotating lamp. Further, the guide icon I3 that guides detailed display of the content of the abnormality detection state is displayed. Further, the buzzer cancellation icon Ix is displayed. Then, when a predetermined time, for example, two seconds have passed from the display state of the display screen V50, the icon I50 is deleted from the display screen V50, and the display screen is made transition to a display screen V51 in which an icon I52 that is a small icon I50 is displayed adjacent to the icon I51, in place of the icon I50. Note that, in the state where the buzzer cancellation icon Ix is displayed, the buzzer cancellation function is allocated to the operation switch F8. By pressing of the operation switch F8, the sound of the alarm buzzer 38 is stopped, the buzzer cancellation icon Ix is deleted, and the fuel efficiency meter window W2 is displayed again.

[A Display Screen Example of when a Plurality of Abnormalities has been Detected]

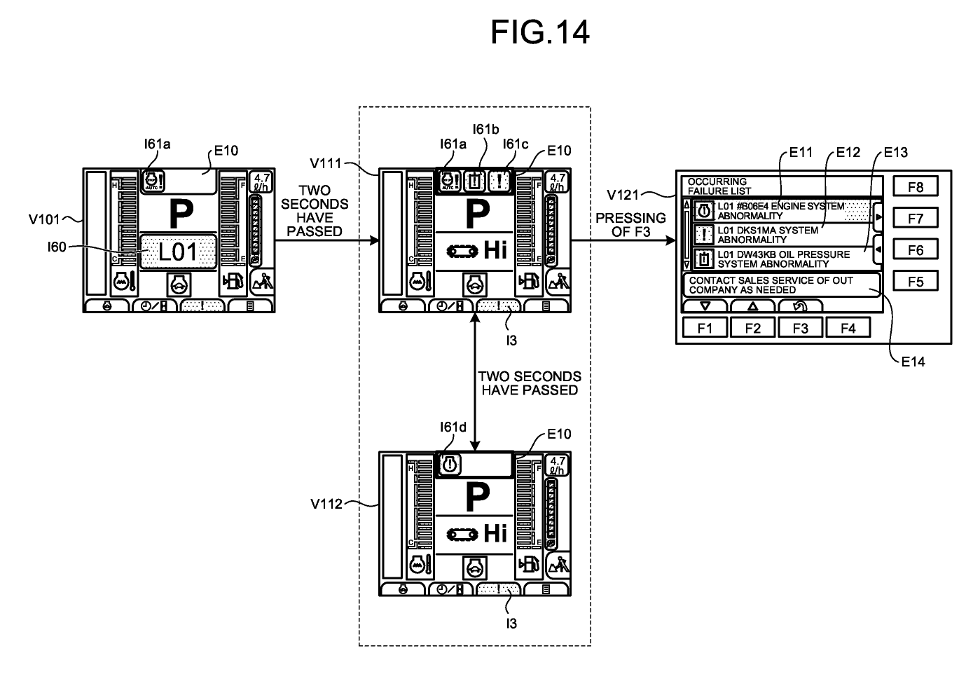

FIG. 14 is a diagram illustrating a screen display example of when four abnormalities of the action code “L01” have been detected. As illustrated in a display screen V101 of FIG. 14, every time the abnormality has been detected, an icon I60 that indicates the action code for a predetermined time. Further, an icon I61a that indicates the type of the abnormality is displayed in a display area E10 in a service meter/clock display window W1 in an upper portion of the icon I60. Then, every time the abnormality of the action code “L01” has been detected, a display screen V111 in which up to three icons I61a to I61c are displayed in order is displayed in the display area E10 of the service meter/clock display window W1. Further, when the fourth abnormality of the action code “L01” has been detected, an icon cannot be displayed in the display area E10, and thus a display screen V112 in which an icon I61d that indicates the fourth abnormality of the action code “L01” is displayed in the display area E10 is displayed, and the display screen V111 and the display screen V112 are alternately switched and displayed every predetermined time. Note that up to three abnormalities can be displayed on the display screen V112. Therefore, when seven or more abnormalities have been detected, three display screens including the display screens in which icons indicating the seven abnormalities are displayed in the display area E10 are alternately switched and displayed.

Note that, when the operation switch F3 corresponding to the guide icon I3 is pressed, the display screen is made transition to a display screen V121 that indicates an occurring failure list. The display screen V121 displays the icons that indicate the types of respective abnormalities, the action codes, the error codes, and the information indicating the content of the abnormality detection states in display areas E11 to E13 corresponding to the respective abnormalities. Then, an abnormality that is currently in a selection state, for example, “abnormality detection corresponding message” for the abnormality displayed in the display area E11 in FIG. 14 is displayed in the display area E14 in a lower portion of the display screen V121. For example, a message of “please contact a sales service man of our company as needed” is displayed. Note that the display area E14 has a limited display space. Therefore, when the message is long, the message is automatically scroll-displayed from right to left, and when display of the end of the message has been completed, the head of the message is displayed again. That is, the message is scroll-displayed, and repeatedly displayed. The operator can see the message displayed in the display area E14 and can take necessary measures.

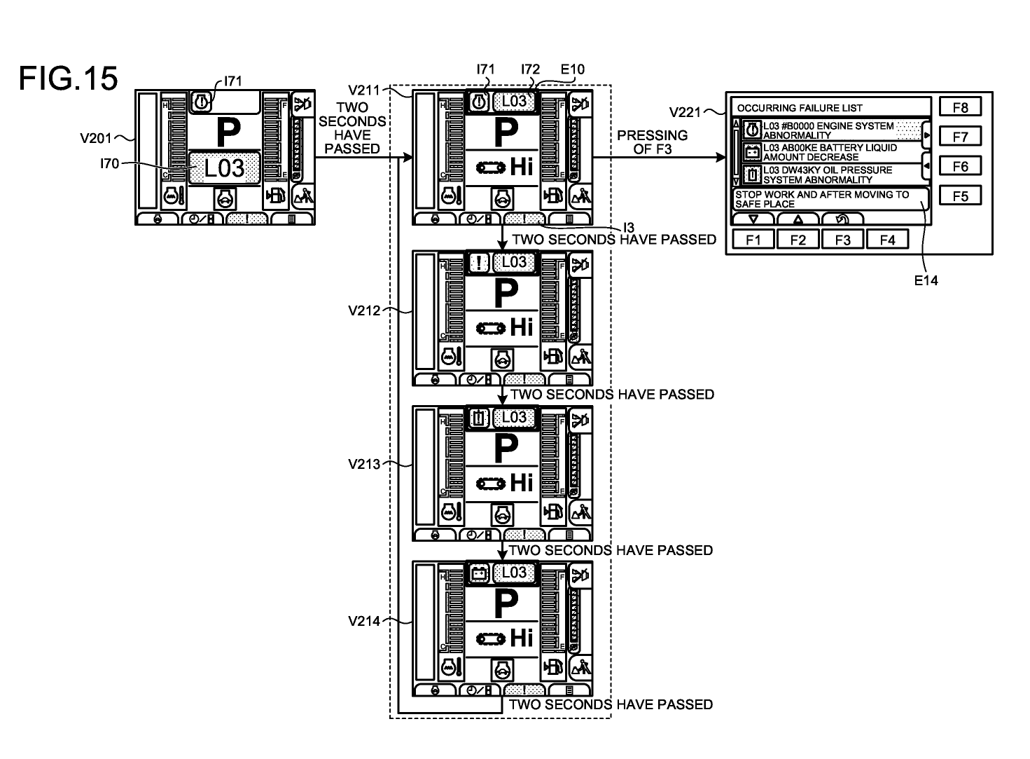

FIG. 15 is a diagram illustrating a screen display example of when four abnormalities of the action code “L03” have been detected. As illustrated in a display screen V201 of FIG. 15, every time the abnormality has been detected, an icon I70 that indicates the action code is displayed for a predetermined time. In this way, every time the abnormality of the action code “L03” has been detected, the display screen is then made transition to a display screen V211 in which an icon I71 that indicates the type of the abnormality and an icon I72 that indicates the action code are displayed in the display area E10 of the service meter/clock display window W1. Following that, when three new abnormalities of the action code “L03” have been detected, four display screens V211 to V214 including display screens V212 to V214 in which the icon that indicates the type of the abnormality and the icon that indicates the action code are displayed in the display area E10 are alternately switched and displayed every predetermined time. Here, when the operation switch F3 corresponding to the guide icon I3 is pressed, the display screen is made transition to a display screen V221 that indicates the occurring failure list. Even in a case where four abnormalities of the action code “L03” have been detected, the “abnormality detection corresponding message” for the abnormality that is currently in a selection state is displayed in the display area E14 in a lower portion of the display screen V221. For example, a message of “please stop the work and inspect the engine after moving to a safe place” is displayed in the display area E14. The operator can see the message displayed in the display area E14, and can take necessary measures.

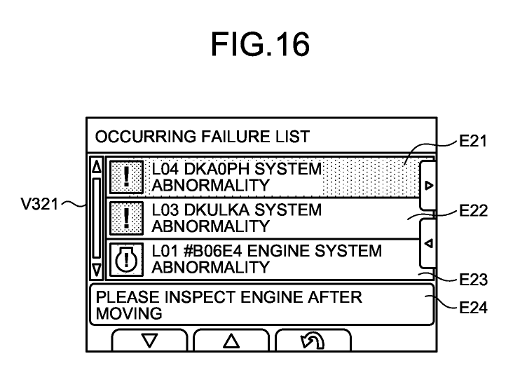

Note that, when a plurality of abnormalities having different action codes has been detected, the display screen becomes a display screen corresponding to an abnormality having an action code of the highest level of the degree of priority. Further, as illustrated in FIG. 16, on a display screen V321 that indicates the occurring failure list due to pressing of the operation switch F4 in this case, information of the plurality of occurring abnormalities is displayed in display areas E21 to E23, and the “abnormality detection corresponding message” corresponding to the action code of the highest level of the degree of priority is displayed in a display area E24 in a lower portion of the display screen V321. That is, when a plurality of abnormalities having different action codes has been detected, the “abnormality detection corresponding message” corresponding to the action code corresponding to the severe abnormality is displayed on the display screen. For example, when a plurality of abnormalities of the action codes of “L03” and “L04” has been detected, the “abnormality detection corresponding message” corresponding to “L04” is displayed on the display screen. The operator can see the message displayed in the display area E24, and can take necessary measures. Note that, when a plurality of abnormalities having action codes of the same abnormality level has been detected, the “abnormality detection corresponding message” for the abnormality level is displayed on the display screen. That is, the “abnormality detection corresponding message” is set to each of the action codes (L01 to L04), and for example, when a plurality of abnormalities having the action code of “L03” has been detected, the “abnormality detection corresponding message” for the action code “L03” is displayed on the display screen.

[The Degree of Priority of an Alarm Buzzer]

When the alarm buzzer 38 is sounded to the content of each abnormality detection state, the degree of priority of the alarm buzzer is set to the detection content of each abnormality. Hereinafter, the degree of propriety of the alarm buzzer will be described. When a plurality of abnormalities has been detected, a sound pattern and effectiveness/ineffectiveness of the buzzer cancellation function of the alarm buzzer 38 are determined according to the degree of priority of the alarm buzzer, as described below. For example, assume that the degree of priority of the alarm buzzer is set to be low to the content of one abnormality detection state, the alarm buzzer 38 is set to sound, the sound pattern is a continuous sound, and the buzzer cancellation function is set to be ineffective. Then, the degree of propriety of the alarm buzzer is set to be high to the content of the other abnormality detection state, the alarm buzzer 38 is set to sound, the sound pattern is a discontinuous sound, and the buzzer cancellation function is set to be effective. In this case, the setting to the content to the abnormality detection state of the one to which the degree of priority of the alarm buzzer is set to be high becomes effective, regardless of the abnormality level of the action code. That is, the alarm buzzer 38 outputs a sound with the discontinuous sound, and the buzzer cancellation icon Ix is displayed at the left side of the operation switch F8, corresponding to the position of the operation switch F8, where the buzzer cancellation function is effective. For example, when a plurality of abnormalities has been detected, the setting of the sound pattern and the buzzer cancellation function of the alarm buzzer 38 are selected and executed corresponding to the detection content of the abnormality having the high degree of priority of the alarm buzzer, according to the set degree of priority of the alarm buzzer.

In the present embodiment, the buzzer cancellation function is not allocated to a dedicated operation switch, and is allocated to the operation switch F8 of the operation switches F1 to F8 that are function switches commonly used in the switching display screens, only when the buzzer cancellation function is necessary. Therefore, even a display device with a limited number of operation switchers, which cannot include a dedicated operation switch to which only a special function is allocated, the display device can allocate the buzzer cancellation function to the operation switch according to the present embodiment. Further, when the buzzer cancellation function is effective, the buzzer cancellation icon Ix is displayed and the buzzer cancellation function is allocated to the operation switch F8 arranged corresponding to the buzzer cancellation icon Ix. Therefore, the operability to the operator can be improved. Further, the buzzer cancellation icon Ix is displayed in a display area of a position (the display area of the fuel efficiency meter window W2 in the present embodiment) where information has been displayed so that the information is not presented to the operator, the information having a lower degree of priority as information that the operator wishes to obtain in a state where an abnormality or a failure has occurred. Therefore, the fact that the sound of the alarm buzzer 33 can be stopped can be precisely presented to the operator. That is, necessary information can be provided to the operator effectively using the limited display screen. Further, determination of whether the abnormality is an abnormality in which the buzzer cancellation function of the alarm buzzer 38 is not effective is made according to the detection content of the abnormality, and the buzzer cancellation icon Ix is displayed or non-displayed. Therefore, the buzzer cancellation icon Ix is not displayed for the detection content of the abnormality that needs a continuous alarm for the operation about asking for prompt measures, and the sound of the alarm buzzer 38 is continued, so that appropriate processing to the abnormality or the failure will not be forgotten and can be executed.

In the above-described embodiment, the buzzer cancellation function is allocated to the operation switch F8. However, the buzzer cancellation function may be allocated to the operation switch F1, for example. That is, when the buzzer cancellation function is allocated to the operation switch arranged at an end portion when the operator operates the operation switch, a wrong operation to press an adjacent operation switch can be prevented. When the buzzer cancellation function is allocated to any of the operation switches, the position where the buzzer cancellation icon Ix is displayed on the display screen is favorably a position where information having a low degree of priority as information that the operator wishes to obtain when an abnormality occurs is displayed in a normal time.

Note that, in the above-described embodiment, the alarm buzzer 38 is provided outside the display device 20. Since a noise is large and the buzzer sound is hard to listen in a working site, the alarm buzzer 38 is arranged close to the operator seat 6. Note that the alarm buzzer 38 may be built in the display device 20.

Further, in the above-described embodiment, the buzzer sound by the alarm buzzer 38 is output as an alarm. However, as means for the alarm output, an output of a voice or LED lighting may be used together with the alarm buzzer 38, or in place of the alarm buzzer 38.

Further, in the above-described embodiment, the buzzer cancellation function is allocated to the operation switch F8. However, the buzzer cancellation function may be allocated to another operation switch. In this case, the buzzer cancellation icon is displayed in a display position corresponding to the allocated operation switch. Note that the buzzer cancellation function is favorably allocated to an upper end/lower end/right end/left end operation switch of the operation unit 32. Further, the operation switch to which the buzzer cancellation function is allocated may be a separated body from the display device 20 and installed in a console or the like provided in the vicinity of the operator seat 6.

Further, in the above-described embodiment, description has been given using the small excavator 1 as an example. However, the present embodiment may be applied to other working vehicles such as middle-sized and large excavators and wheel loaders, other than the small excavator. Further, the size of the display unit of the display device described in the present embodiment can be appropriately changed in accordance with the working vehicle to be applied.

### REFERENCE SIGNS LIST

1 Small excavator
2 Lower traveling body
3 Upper swing body
4 Blade
5 Working machine
6 Operator seat
7 Working machine lever
8 Travel lever
9 Operation pedal
11 Support
12 Roof
13 Support arm
20 Display device
31 Display unit
32 Operation unit
33 Abnormality detection unit
34 Alarm output processing unit
35 Cancellation function allocation unit
36 Screen display control unit
37 Storage unit
38 Alarm buzzer
39 Sensor
C Controller
C1 Display device controller
F1 to F8 Operation switch
I1 to I8 Guide icon
Ix Buzzer cancellation icon
SW Key switch
V1 to V4, V11, V12, V20, V21, V30, V31, V40, V41, V50, V51 Display screen
W2 Fuel efficiency meter window

1. A display device of a working vehicle, comprising:
a display screen configured to display an operation state of the working vehicle;
an operation unit configured to switch display of the display screen;
an abnormality detection unit configured to detect an abnormality of the working vehicle;
an alarm output processing unit configured to perform an alarm output according to an abnormality detection state detected by the abnormality detection unit; and
a cancellation function allocation unit configured to allocate a function to cancel the alarm output to the operation unit, wherein
the alarm output processing unit performs processing of canceling the alarm output when an operation of the operation unit is performed in a state where the function to cancel the alarm output has been allocated.

2. The display device of a working vehicle according to claim 1, wherein the cancellation function allocation unit allocates effectiveness/ineffectiveness of the function to cancel the alarm output to the operation unit according to the abnormality detection state detected by the abnormality detection unit.

3. The display device of a working vehicle according to claim 1, further comprising:
a screen display control unit configured to perform guide display that guides cancellation of the alarm output by the operation unit is possible on the display screen when the cancellation function allocation unit allocates the function to cancel the alarm output to the operation unit.

4. The display device of a working vehicle according to claim 3, wherein the screen display control unit performs guide display as a guide icon in a position on the display screen corresponding to a position of the operation unit.

5. The display device of a working vehicle according to claim 4, wherein the operation unit is arranged at an end portion of the display device, and the guide icon is arranged in an adjacent position corresponding to the operation unit and an end portion of the display screen.

6. A display device of a working vehicle, comprising:
a display screen configured to display an operation state of the working vehicle;
an operation unit configured to switch display of the display screen;
an abnormality detection unit configured to detect an abnormality of the working vehicle;
an alarm output processing unit configured to perform an alarm output according to an abnormality detection state detected by the abnormality detection unit;
a cancellation function allocation unit configured to allocate effectiveness/ineffectiveness of a cancellation function of the alarm output to a specific operation switch arranged at an upper right end of the operation unit according to the abnormality detection state detected by the abnormality detection unit; and
a screen display control unit configured to perform, when the cancellation function allocation unit allocates the cancellation function of the alarm output to a specific operation switch of the operation unit, guide display that guides cancellation of the alarm output by the specific operation switch is possible at an upper right end on the display screen and in a position corresponding to a position of the specific operation switch, wherein
the alarm output processing unit performs processing of canceling the alarm output when an operation of the specific operation switch is performed in a state where the cancellation function has been allocated to the alarm output.

7. A display method of a display device of a working vehicle including a display screen that displays an operation state of the working vehicle, and an operation unit that switches display of the display screen, the method comprising:
an abnormality detection step of detecting an abnormality of the working vehicle;
an alarm output processing step of performing an alarm output according to an abnormality detection state detected by the abnormality detection step;
a cancellation function allocation step of allocating a function to cancel the alarm output to the operation unit; and
an alarm output cancellation step of canceling the alarm output when an operation of the operation unit is performed in a state where the function to cancel the alarm output has been allocated.

8. The display method of a display device of a working vehicle according to claim 7, wherein the cancellation function allocation step allocates effectiveness/ineffectiveness of the function to cancel the alarm output to the operation unit according to the abnormality detection state detected by the abnormality detection step.

9. The display method of a display device of a working vehicle according to claim 7, further comprising:
a screen display control step of performing guide display that guides cancellation of the alarm output by the operation unit is possible on the display screen when the cancellation function allocation step allocates the function to cancel the alarm output to the operation unit.

10. The display method of a display device of a working vehicle according to claim 9, wherein the screen display control step performs guide display as a guide icon in a position on the display screen corresponding to a position of the operation unit.

11. The display method of a display device of a working vehicle according to claim 10, wherein the operation unit is arranged at an end portion of the display device, and the guide icon is arranged in an adjacent position corresponding to the operation unit and an end portion of the display screen.

12. A working vehicle comprising the display device including:
a display screen configured to display an operation state of the working vehicle;
an operation unit configured to switch display of the display screen;
an abnormality detection unit configured to detect an abnormality of the working vehicle;
an alarm output processing unit configured to perform an alarm output according to an abnormality detection state detected by the abnormality detection unit; and
a cancellation function allocation unit configured to allocate a function to cancel the alarm output to the operation unit, wherein
the alarm output processing unit performs processing of canceling the alarm output when an operation of the operation unit is performed in a state where the function to cancel the alarm output has been allocated.

13. The display device of a working vehicle according to claim 2, further comprising:
a screen display control unit configured to perform guide display that guides cancellation of the alarm output by the operation unit is possible on the display screen when the cancellation function allocation unit allocates the function to cancel the alarm output to the operation unit.

14. The display device of a working vehicle according to claim 13, wherein the screen display control unit performs guide display as a guide icon in a position on the display screen corresponding to a position of the operation unit.

15. The display device of a working vehicle according to claim 14, wherein the operation unit is arranged at an end portion of the display device, and the guide icon is arranged in an adjacent position corresponding to the operation unit and an end portion of the display screen.

16. The display method of a display device of a working vehicle according to claim 8, further comprising:
a screen display control step of performing guide display that guides cancellation of the alarm output by the operation unit is possible on the display screen when the cancellation function allocation step allocates the function to cancel the alarm output to the operation unit.

17. The display method of a display device of a working vehicle according to claim 16, wherein the screen display control step performs guide display as a guide icon in a position on the display screen corresponding to a position of the operation unit.

18. The display method of a display device of a working vehicle according to claim 17, wherein the operation unit is arranged at an end portion of the display device, and the guide icon is arranged in an adjacent position corresponding to the operation unit and an end portion of the display screen.
